(19) United States
(12) Patent Application Publication
(10) Pub. No.: US 2005/0268794 A1
(43) Pub. Date: Dec. 8, 2005

(54) Spool rotisserie system

(76) Inventor: Yuriy Nesterov, N. Miami B., FL (US)

Correspondence Address: YURIY NESTEROV, 16851 NE R3 AVE #B - 321, NORTH MIAMI BEACH, FL, 33160, US

(21) Appl. No.: 10/862,669

(22) Filed: Jun. 7, 2004

(51) Int. Cl. A23P 1/00

(52) U.S. Cl. 99/427

(57) ABSTRACT

A spool rotisserie system enables rotisserie cooking in home ovens. The energy transmits from an outside motor to the spool rotisserie system through a fiberglass line. The rotisserie system includes an arm with a bearing support and a bearing assembly on one side of a base. The opposite side of the base having a rotisserie driven embodiment. The driven embodiment includes a frame connected to the base and two beams of the frame are carrying a sliding spool. Two rods hold a food and supported by the bearing assembly at one side and by the sliding spool at the opposite side. A cover positioned on two horizontal bars of the frame above the sliding spool. A housing connected to the cover by one end and to a motorized spool enclosure by the other end. The line winded about the sliding spool and passed through the housing to a motorized spool, where the motorized spool engaged a motor. The rotisserie system can be easily dismounted and placed in a strong case. The storing case is small enough to fit any standard kitchen cabinet. A capturing slots food basket for the rotisserie system includes a hinged frame and two grids. The frame has a plurality of horizontal slots and can be opened and closed in horizontal projection. Each of the grids has four corresponding to the slots flanges.

### CROSS-REFERENCE TO RELATED APPLICATION

Not Applicable

### SEQUENCE LISTING

Not Applicable

### FIELD OF INVENTION

This invention relates to cooking devices and particularly to rotisserie type cooking machines.

### BACKGROUND OF THE INVENTION

Rotisserie method of cooking become very popular in nowadays. This method gives us many benefits in our life. Rotisserie method is the most simple way of cooking. Also cooked by this method foods are very tasty and have the most nutrients.

As an example, there is well known “Atkins” approach to a healthy lifestyle. “Atkins” approach generally based on proteins, vegetables, and fruits, but rejects hydrogenated oils and sugars. In the rotisserie method there is no need for using oil in the cooking process. Burgers, chicken, fish, turkey, leg of lamb, or primer ribs, as well as vegetables, or fruits can be cooked by rotisserie machines without adding oil. Also during cooking all the unhealthy fat melts and drops from the food. Other cooking methods need to use oil. In the other methods fat and oil collects and settle on the food being cooked.

Another benefit of the rotisserie method is nutritiousness. Rotisserie method of cooking is one of those where the cooking time is just enough to have food being cooked. This method provides us with the most nutrients. In those methods where food have been cooked for a long time, the majority of enzymes and vitamins will be destroyed. In contrast we can benefit from rotisserie cooking by receiving the most enzymes and vitamins from food.

Also rotisserie method is not only nutritional and healthy, but the same time most flavorful and tasty. During the cooking flavorful crust is created. This crust keeps juices inside the food. Juiciness and crust are distinctive futures of the food cooked by rotisserie method.

Finally, rotisserie method is the most simple way of cooking. No special culinary knowledge or skills are required. Only some basic seasoning is needed. All the work the rotisserie machine will do for you. No attention or personal contact with the food is required during the cooking time.

All our homes and apartments have kitchens equipped with standard ovens. These standard ovens do not have rotisserie system. Even though, many rotisserie systems for home ovens were designed. Out of all these rotisserie designs only few were commercialized. Mostly these rotisserie systems never become widely popular. And there are many weak sides of these rotisseries systems.

In some designs rotisserie motor was placed in the back or side wall of an oven. Unfortunately these designs were not widely commercialized and generally only customized rotisserie ovens are available.

The fact that our home ovens have no rotisserie assembly generated a number of small ovens with rotisserie assembly in them. All these small ovens have many weak sides and disadvantages.

Some of these small ovens can perform only one cooking technique. As an example: shish kebab machines.

Another example, are those rotisserie machines which can cook only one chicken. If you need to cook two chickens, you have to buy bigger size machine. A family of 4 or 6 people would need to buy a big rotisserie machine. Unfortunately these big machines are pricey. For example, the least expensive home oven would cost under 200 dollars. A big rotisserie machine, its gadgets, plus shipping and handling would bring the price over 200 dollars. That means, not every family can enjoy healthy and tasty “rotisserie”.

We already have ovens in our kitchens. How much space can we give to the small oven? Even though they are small ovens but still taking considerable space in our kitchens. Add here also heat damage restrictions. Manuals of the small ovens restrict to have any objects close than 8 inches around the small ovens. The heat damage restrictions and actual size of the oven need to take a big chunk of a kitchen countertop and actual space. In average kitchen size this machine can take as mach as ⅓ of the countertop.

The cooking process itself is disrupted in small ovens. The size of cooking cavity of small ovens is limited. Food generally hardly fits in small ovens. This situation interrupts free air circulation during rotisserie. The food itself acts as insulation. This makes cooking process uneven. The food would be burning next to the heating element, whereas cooling down next to the door side. This situation would slow down cooking of the meat inside and will create heavy crust outside. Generally, small ovens rotisserie give us small results.

Next, these machines have multiple gadgets. These gadgets are: gloves, meat thermometer, food basket, rods, flavor injector, food ties, kabob rods, heating tray. All the gadgets need a special storing place, or may need many different storing areas. That makes assembly and food preparation more complex.

In some designs rotisserie gadgets of small ovens have assembling parts which need screwing. These screwing parts are mostly malfunction under vibration during rotisserie.

Other problems in small ovens with rotisserie assembly are pinning rods and actual food size. First you need to shop for the food by its size. Then, when you pinning the food on rod or rods, you need to do it with exact symmetry. The food needs to be placed on the spit or spits with precise accuracy. If you cannot centered the food on spits, it may touch heating element. The food can be burned, stop rotation, or even make a fire. Also fixed dual spits more difficult to aim into the food. Dual fixed spits more difficult to control during pinning. It carries a danger to puncture the arm.

Special preparation is needed for cooking fowl in small ovens rotisserie machines. Legs and wings are required to be tied to the fowls body. During cooking muscles of meat changing their form. Ties create negative pressure on the fowls muscles. This pressure makes fowl leak juices in order to adjust to the food ties. Fowl cooked in this condition would leak juices and become dry.

All the rotisserie machines have only one rotational speed. This is disadvantage in rotisserie cooking. By the well known cooking principle the first is searing, then cooking, and at the end simmering. Searing is the first step which locks juices inside meats. Searing means: slow rotational speed and high heat. Searing generally in these rotisserie machines has to be done manually. You have to turn on and off power of the motor during the searing time.

Cleaning of the small ovens with rotisserie assembly is still complex. You need to clean not only gadgets, but the small ovens itself. It is difficult to reach all areas inside the small ovens due to the small size. And generally they do not have cleaning cycle. Due to the small size there are many areas difficult to clean. Detergent can be left in difficult to clean areas. Left detergents can give undesirable smell, can evaporate and penetrate the food

Next disadvantage is storing. When we do not cook, we like to have our countertop clean and free from any equipment. These small ovens do not fold for storing. They are just to bulky and heavy for moving from one place to another and too big to find an extra space inside a cabinet. Inability to fold and storing difficulties are weak sides of the small ovens with rotisserie assembly.

There are variety of food baskets. Some of the food baskets specially designed for rotisserie machines. These baskets are not well developed. Their designs have weak sides. One of them is burning of the food sides. During rotisserie cooking the sides of the food would be burned, whereas center of the food still raw. When the food basket spins, the edges move very close to the heating element. Food in these baskets never cooks evenly. Another disadvantage is difficulty of taking food out of the basket. Even though some baskets have nonstick coating, still food stick to basket. Fish is the most sticking food. The baskets designs make taking of the fish from baskets difficult. Fish usually stick to rods of the baskets and cannot be taking out without braking the fish.

Accordingly, several objects and advantages of my invention are:

The first important feature of my spool rotisserie system is that it can be dismounted for easy storing. The parts of the rotisserie system are designed for easy assembling or dismounting. Storing case is designed for storing rotisserie system and gadgets. Gadgets and the system can be stored in the case. Rectangular shape and small size allow to put the case in any kitchen cabinet. My rotisserie system does not need a special storing place, any place is good for storing the case with rotisserie system.

This rotisserie system does not take any space of a countertop. You can enjoy clean and neat kitchen every day. Use this system when needed and store it in any place in the kitchen after use. You can use all the countertop space, as you need, for different cooking tasks.

The case have space not only for rotisserie system but also for gadgets. This advantage makes preparation for cooking logical, simple, and convenient. Assembling of the system takes only seconds. You have all the gadgets in one place, in the case, ready to accommodate any rotisserie cooking tasks. Also in my rotisserie system all the parts and gadgets do not need screws for assembling.

Pinning of the food is safe and easy. Two independent not fixed rods make it possible. Insertion of one rod at the time is safe. It is easy to maneuver one rod though the meat. Also the pinning do not have to be with precise accuracy. There are always enough space between food and heating element. Even asymmetrically pinned food will not touch heating element.

My rotisserie system can cook two horizontally placed chickens, or whole leg of lamb or whole strip of barbecue ribs.

No special preparation is needed for cooking fowl. The legs and wings of fowl do not have to be tied to its body. Wings can be twisted and legs just to be tied together. Fowl come from my rotisserie with the most juice and exceptional taste.

Another very important advantage of my rotisserie system has come naturally. By using “spool-line-spool” system, speed in my rotisserie changes gradually. The line unwinds from first spool and winds up about second spool. Thus, circumference of the line in the first spool decreases. As circumference of the line in the second spool increases, speed of the rotations also increases. My rotisserie system starts cooking with slow speed for searing. This speed gradually increases as cooking progresses. My system sears and cooks food itself. No special attention is needed.

My rotisserie system is designed to use foil for collecting grease. If you do so, you do not have to clean my system at all. But the same time it can be washed if needed. Open construction of my system provides good cleaning control.

Next, my system is designed for using standard oven for rotisserie cooking. New ovens have the most technologically advanced parts. Convectional cooking, roasting, and broiling techniques can be utilized by my system. Even old standard ovens still superior to small ovens. Spacious cavity of standard ovens gives excellent air circulation and heat distribution. This always gives exceptionally juicy and crusty “rotisserie”. The whole idea of my rotisserie system is not to duplicate an oven. Build a rotisserie system witch can cook inside standard ovens. The fact, that my system does not duplicate any parts of an oven makes my system simple for manufacturing. The price of my system excludes cost of all duplicated parts of an oven, as it is in small ovens.

The core idea of my rotisserie system is to have simple and inexpensive rotisserie machine. To overcome lurching problem conical axle construction for spool rotisserie system was invented. The advantage of my system is that it used three fulcrums principle. The spit with food is supported by one fulcrum at one end and by two fulcrums at the order end. Three fulcrums principle makes distribution of the food weight more even, thus prevents lurching. The advantage is that the principle keeps the rotisserie system simple. No special assembling parts is needed for overcoming lurching

Food basket in my rotisserie system has several advantages. Rectangular shape frame of the basket protects food from burning. Strip of metal makes rectangular frame shape. This frame protects food from burning at edges. When a side of the frame comes close to a heating element, it reflects the most of the heat. Thus, it protects food from burning at the edges and makes cooking even. Hinged frame and two independent grids are designed for easy food removing. When food is cooked, it is easy to remove the top grid from the food. This advantage prevents food from braking. You can take food piece by piece from the bottom grid, or present the food in the bottom grid.

### SUMMARY OF THE INVENTION

Present invention is spool rotisserie system. Spool rotisserie system enable to perform rotisserie cooking method inside oven cavity. Rotational power transmitted through the line, from outside motor, to rotisserie system poisoned inside standard home oven cavity. Conical axle construction prevents food from lurching. This system can be dismounted for easy storage. The case is designed for storing the rotisserie system and gadgets. The case with gadgets and rotisserie system can be put in a cabinet. The case is designed to fit any standard kitchen cabinet. Spool system makes cooking process natural. Food basket prevents food from burning at sides. Two independent grids of the basket facilitate food removal and presentation.

### BRIEF DESCRIPTION OF THE DRAWINGS

FIG. 1 is a perspective distorted view drown from a photograph of a spool rotisserie system in its assembled stage, where a motorized spool enclosure and conventional motor appeared enlarged.

FIG. 2A is a perspective view of a rotisserie station.

FIG. 2B is a perspective view of the rotisserie station having a bearing support.

FIG. 3 is an enlarged perspective view of the bearing support.

FIG. 4 is an enlarged shorten view of rotisserie rods.

FIG. 5A is an enlarged side view of a bearing assembly.

FIG. 5B is an enlarged top view of the bearing assembly as it positioned horizontally.

FIG. 6A is a perspective side view of a rods holder.

FIG. 6B is a perspective front view of the rods holder.

FIG. 7 is a preassembled distorted perspective view drown from a photograph of a rotisserie driven embodiment.

FIG. 8 is an exploded corner view of a motorized spool enclosure.

FIG. 9 is a corner view of a motor in relation to the FIG. 8

FIG. 10 is a perspective view of the spool rotisserie system showing how to practice the system.

FIG. 11 is a perspective view of preassembled position of the rotisserie driven embodiment for its rewinding cycle.

FIG. 12A is an enlarged side view of a rewinding frame.

FIG. 12B is an enlarged front view of the rewinding frame.

FIG. 13 is a perspective view of the rewinding frame in relation to a sliding spool.

FIG. 14A is a perspective side view of the motorized spool enclosure.

FIG. 14B is a side view of the rotisserie driven embodiment.

FIG. 15 is a scheme showing a conical axle construction.

FIG. 16A is a perspective view of a storing case.

FIG. 16B is an enlarged view of a frame chamber wall.

FIG. 16C is an enlarged view of an arm chamber wall.

FIG. 17A is a top view of the case showing how long gadgets accepted through the wall cutouts.

FIG. 17B is a perspective view of the case as it is covered by a base of the rotisserie system.

FIG. 17C is a perspective view of the case chambers in relation to the rotisserie station.

FIG. 18A is a side view of grids.

FIG. 18B is a side view of the grids showing various grids positions.

FIG. 18C is a perspective view of the grids.

FIG. 19A is a top view of a capturing slots food basket.

FIG. 19B is a perspective view of a frame of the food basket.

FIG. 20A is a principal view of a single axle alternative embodiment.

FIG. 20B is a view of a principle of transmitting rotational energy by moving line back and forth.

FIG. 20C is a view of a principle of transmitting rotational energy by rotation.

FIG. 20D is a principle view of a dual spool alternative embodiment.

### DETAILED DESCRIPTION OF THE DRAWINGS

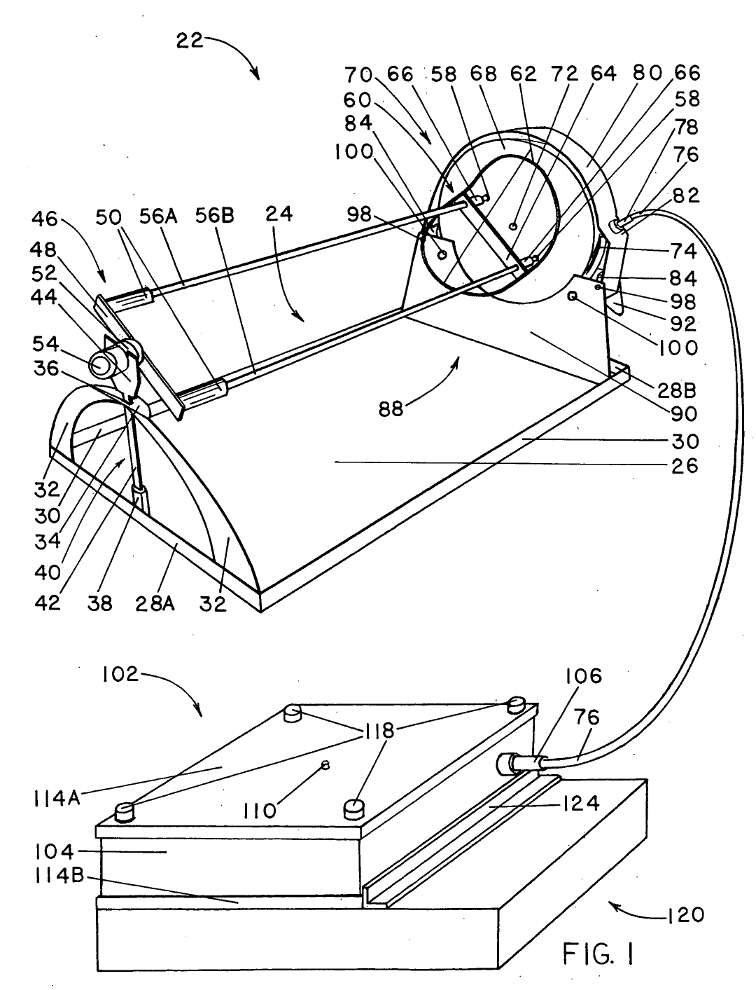

FIG. 1 is a perspective distorted view of a spool rotisseries system 22 in its assembled stage. Rotisserie system 22 having a rotisserie station 24 with assembling parts and a motorized spool enclosing 102 positioned on a motor 120. A rotisserie driven embodiment 70 communicated with spool enclosure 102 through a line 74 which enclosed by a housing 76.

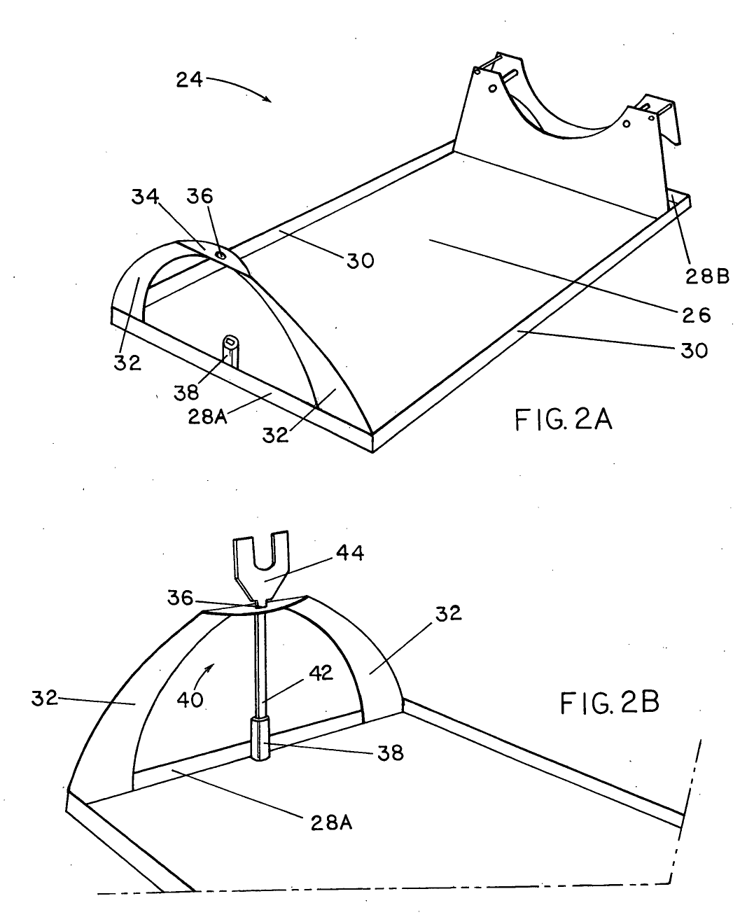

Referring to FIG. 1 and as best shown in FIG. 2A, rotisserie station 24 includes a base 26 having two generally upwardly extended sidewalls 28A, 28B and two longitudinal walls 30.

Side wall 28A has a rainbow shape arm 32. Arm 32 attached to wall 28A and arising vertically to culminate into a diversion 34 at its top. Diversion 34 generally takes horizontal plane and has a slot 36. Slot 36 aimed straight downward into a hollow upright member 38. Hollow upright member 38 attached to base 26 just next to wall 28A.

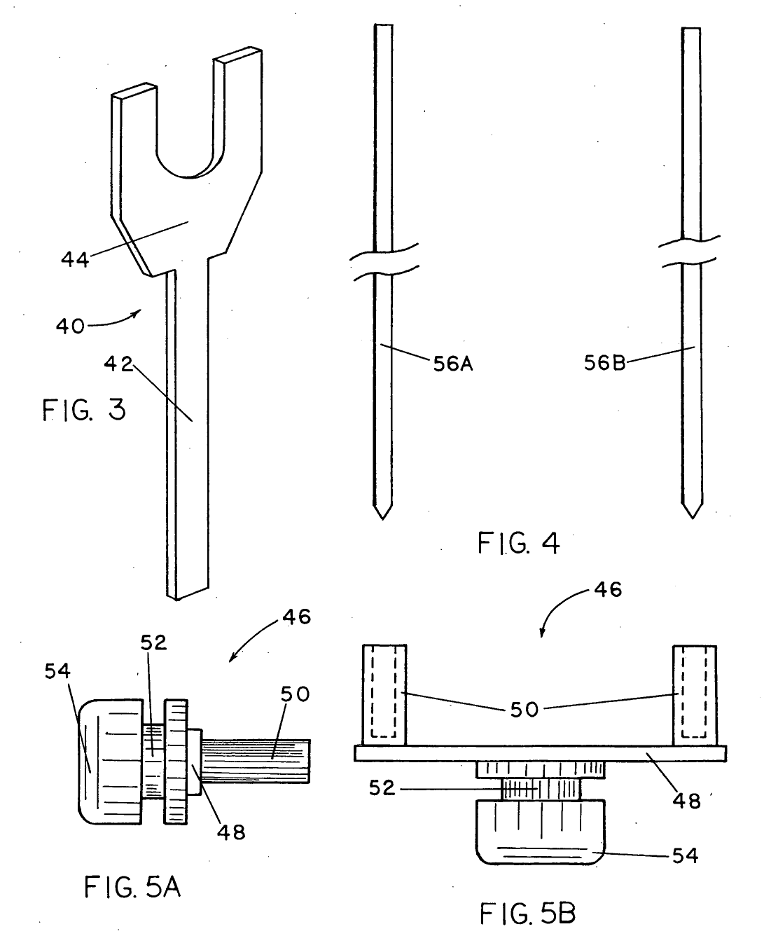

FIG. 2B and an enlarged view in FIG. 3 show a bearing support 40. Bearing support 40 has a stem 42 and a “U” shape head 44. Bearing support 40 inserted through slot 36 into hollow upright member 38.

FIGS. 5A and 5B are enlarged and detailed views of a bearing assembly 46. Bearing assembly 46 having a bearing 52. One side of bearing 52 elongated and shaped into a bearing knob 54, and the opposite side has a bearing assembly crossbar 48. Crossbar 48 has two rod receptacles 50 spaced apart and attached to the crossbar. As shown in FIG. 1, bearing assembly 46 is positioned on bearing support 40 into “U” shape head 44.

FIG. 4 is an enlarged view of two rods 56A and 56B. As shown in FIG. 1, Rod 56A and 56B inserted by its sharpened ends into receptacles 50. The opposite ends of rods 56A and 56B, before they interred two rods receiving holes 58 of a sliding spool 68, have passed through two cylinders 66 of a rods holders 60.

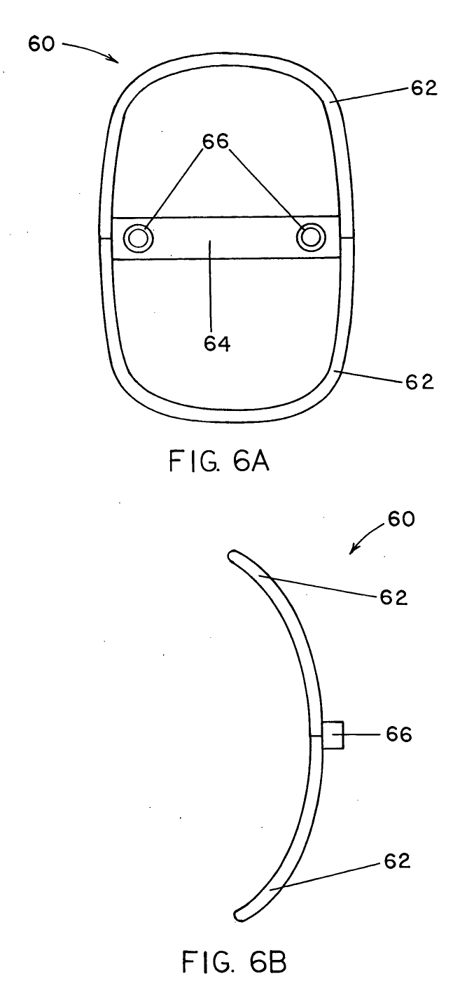

As best shown in FIGS. 6A and 6B, rods holders 60 has two holder arms 62 connected by a crossbar 64. Two arms 62 having curved profile, whereas two cylinders 66 attached to cross bar 64 and pointed outside to the curved profile of arms 62.

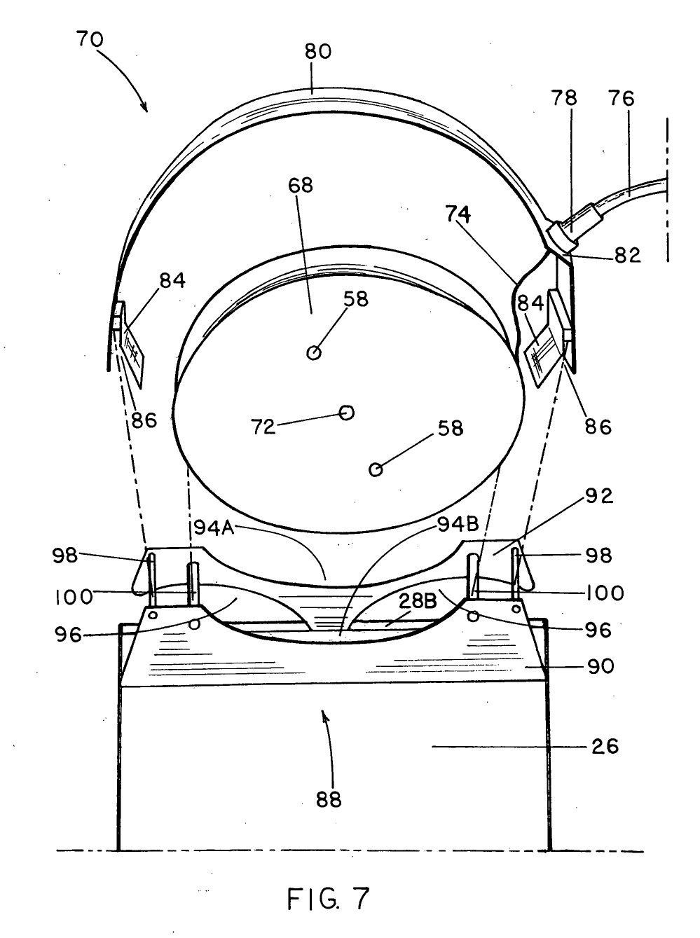

FIG. 1 and more detailed FIG. 7 show rotisserie driven embodiment 70 the central part of driven embodiment 70 is sliding spool 68. Sliding spool 68 has a central aperture 72 and two rod receiving holes 58. Sliding spool 68 positioned on two beams 100 of a rotisserie frame 88.

Rotisserie frame 88 having an inner frame wall 90 and an outer frame wall 92 connected by two beams 100 and two horizontal bars 98. Frame wall 90 and wall 92 have upper edges central cutouts 94A and 94B, respectively. In addition, wall 92 has two side cutouts 96. Rotisserie frame 88 attached to base 26 and side wall 28B.

A cover 80 is a convex strip of metal having a directional bend 82 of its one side and two aprons 84 connected to inner surface at each end of the cover. Thereby two ogives 86 created by the aprons connection.

As shown in FIG. 1, sliding spool 68 positioned on beams 100 and cover 80 positioned on horizontal bars 98 by its ogives 86. Line 74 winded about sliding spool 68 and passed through housing 76, where housing 76 connected to directional bend 82 by a cover holding member 78 and opposite end of housing 76 connected to a cadre 104 by a cadre holding member 106.

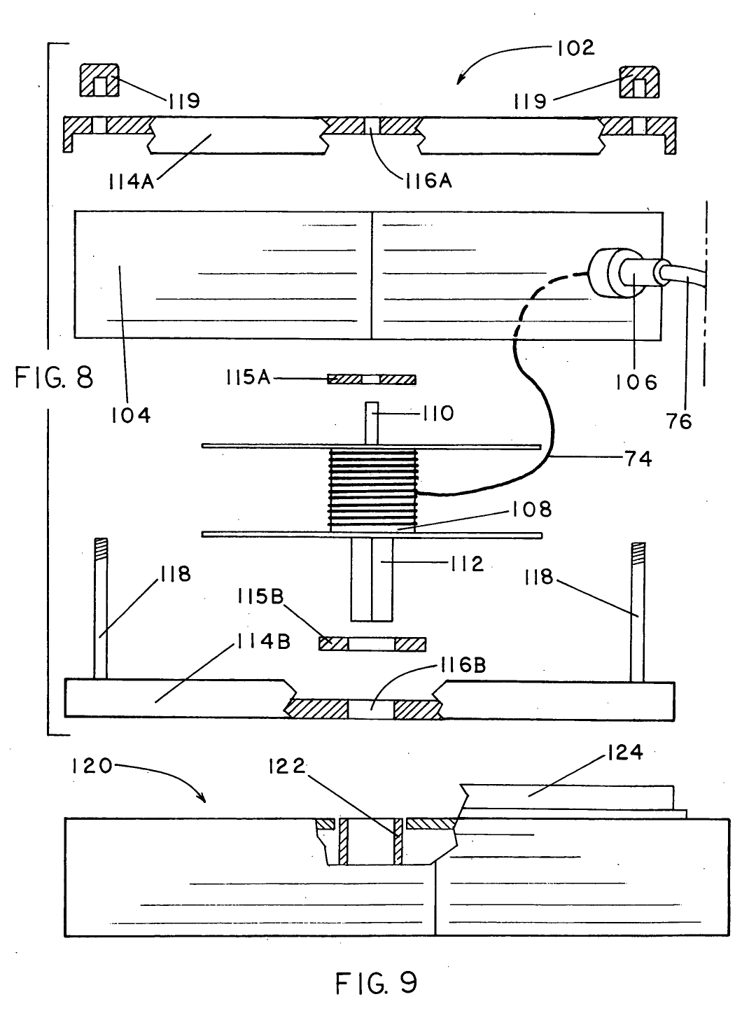

Referring to FIG. 1 and FIG. 8, housing 76 extended from cover 80 and attached to cadre 104 by holding member 106. Line 74 has passed through housing 76 from sliding spool 68 to a motorized spool 108. Motorized spool 108 has a rotary shaft 110 on one side and driving shaft 112 on the opposite side. A driving shaft washer 115B corresponded to driving shaft 112 and a rotary shaft washer 115A corresponded to rotary shaft 110. Motorized spool 108 enclosed into motorized spool enclosure 102. Enclosure 102 comprised of cadre 104, and mostly flat a top plate 114A, and mostly flat a bottom plate 114B. Bottom plate 114B has a driving shaft aperture 116B in its center and several bolts 118 on the sides. Top plate 114A has a rotary shaft aperture 116A in its center and several legs 119. Legs 119 corresponded to bolts 118 as nuts structures.

As shown in FIG. 1 and FIG. 9, motor 120 has a rotary drive socket 122 and a stopper 124. Motorized spool enclosure 102 positioned against stopper 124, where shaft 112 engaged sockets 122.

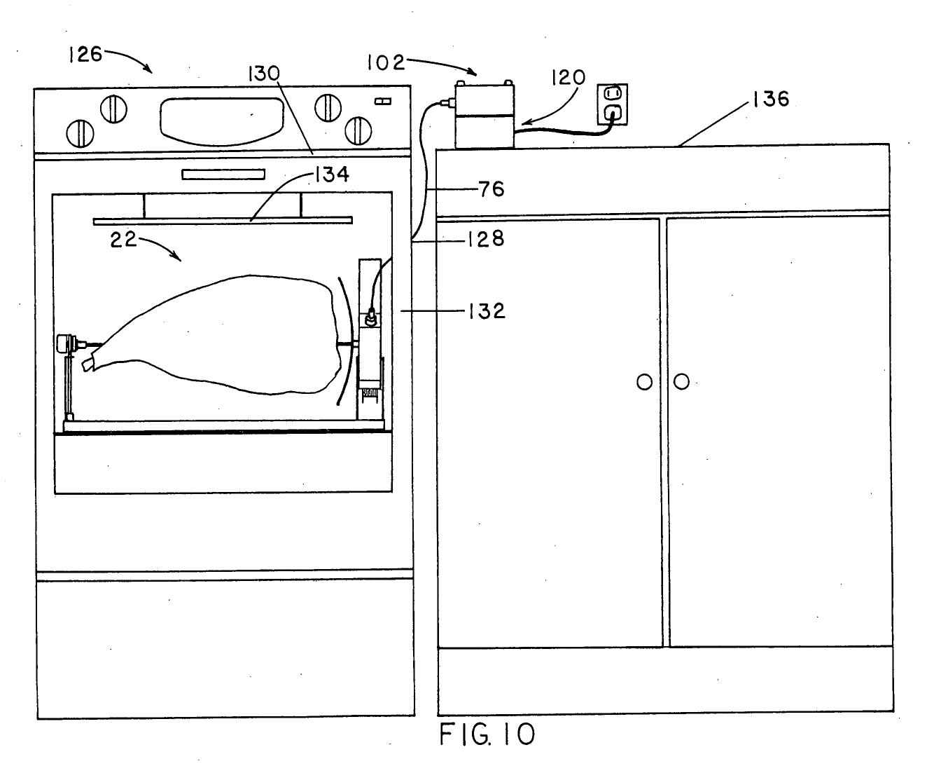

FIG. 10 shows spool rotisserie system 22 in its working position. Rotisserie system 22 placed inside an oven 126 under a heating element 134. Housing 76 placed in a gap 128, which is standard space between an oven body 130 and an oven door 132. Motor 120 having motorized spool enclosure 102 placed on a countertop 136, just next to the oven.

Phantom lines, in scheme of FIG. 15, show a conical axle 206. Where shading lines show an axle base 206 and phantom lines 206 united to form an axle top 210. Diameter of the base 208 is in direct relation to a distance between beams 100, which shown by a relational arrowed line 212.

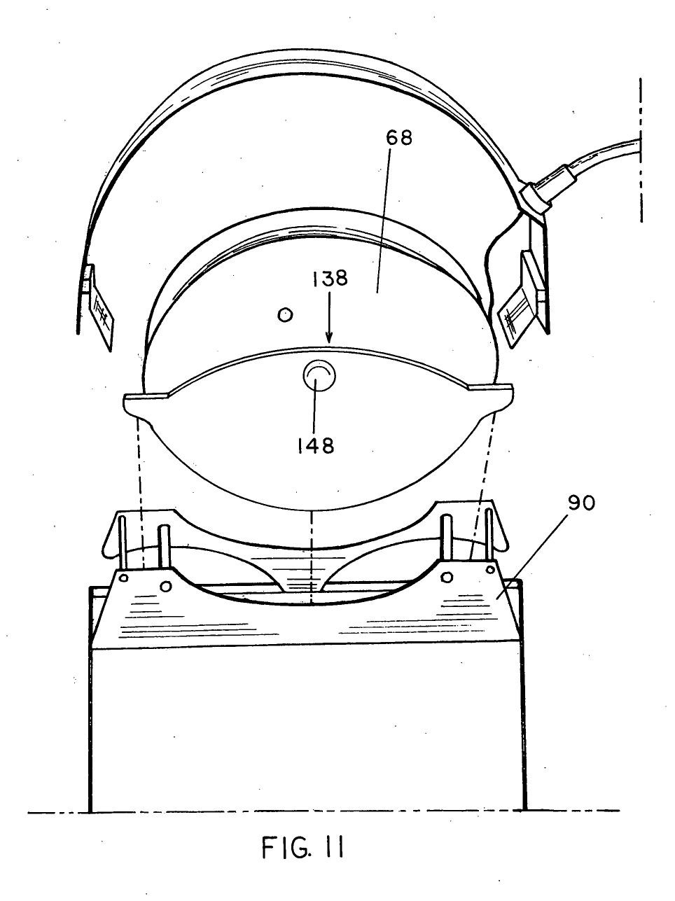

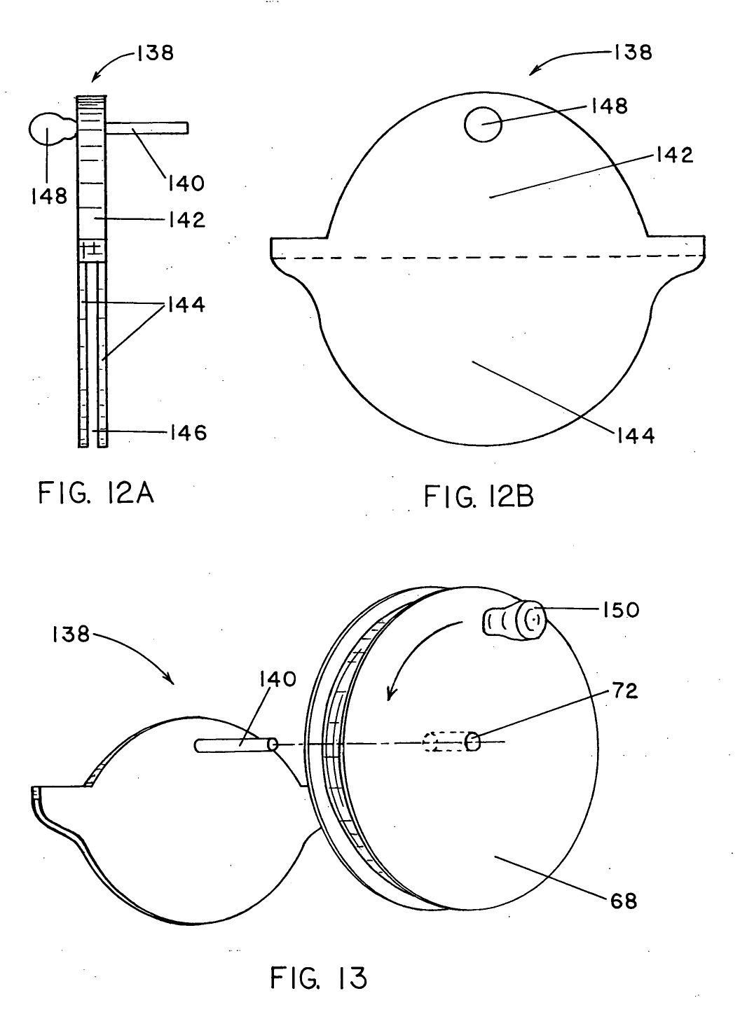

As shown in FIG. 11, spool 68 positioned on a rewinding frame 138 for rewinding cycle. More detailed views in FIGS. 12A,12B,and 13 show rewinding frame 138. Rewinding frame 138 having a frame head 142 and two parallel cheeks 144, where a frame gap 146 is the space between cheeks 144. Head 142 of rewinding frame 138 has a rewinding axle 140 on one side and a frame knob 148 on the opposite side.

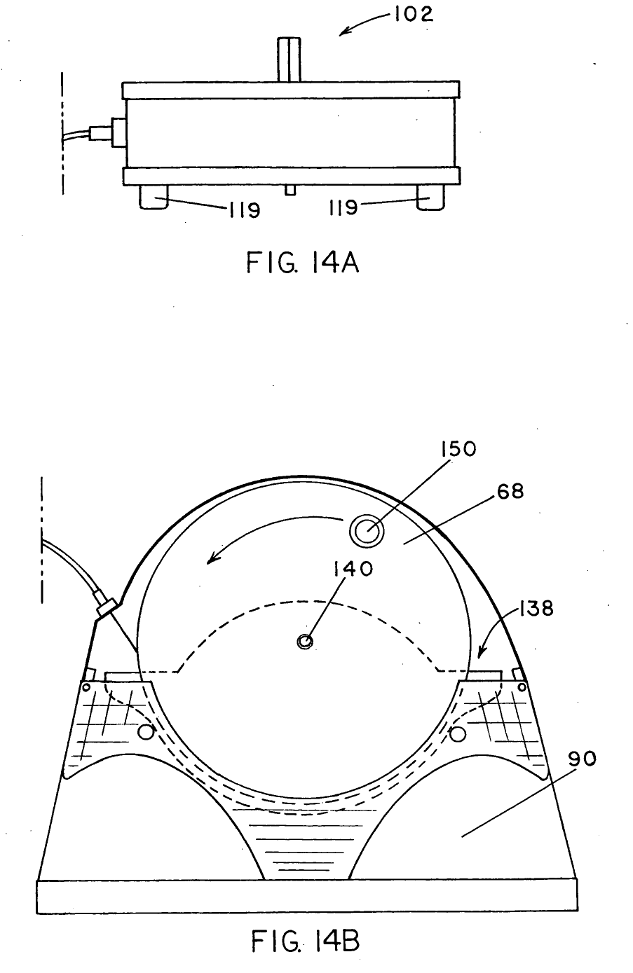

As shown in FIG. 14B, spool 68 has a rewind knob 150 and positioned on axle 140. Frame 138 having spool 68 positioned on wall 90. As illustrated in FIG. 14A, motorized spool enclosure 102 positioned on its legs 119 for rewinding cycle.

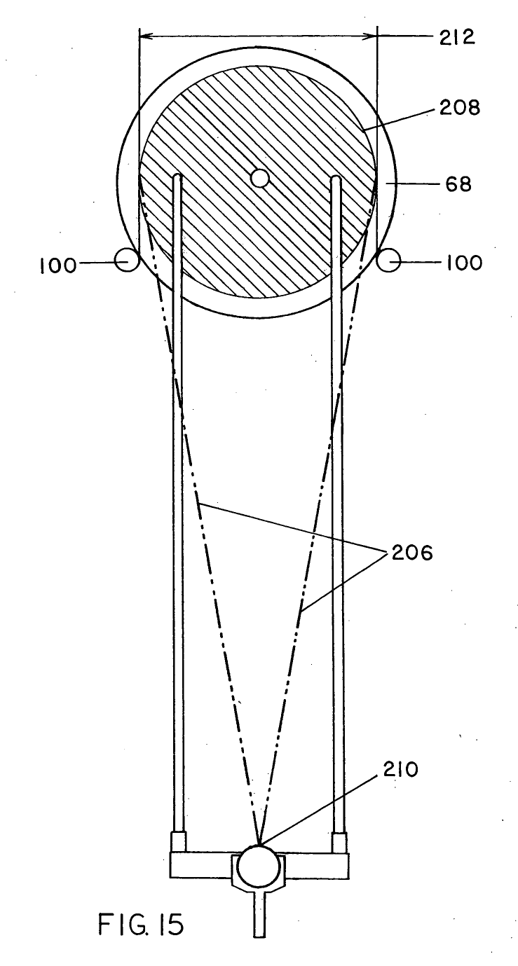

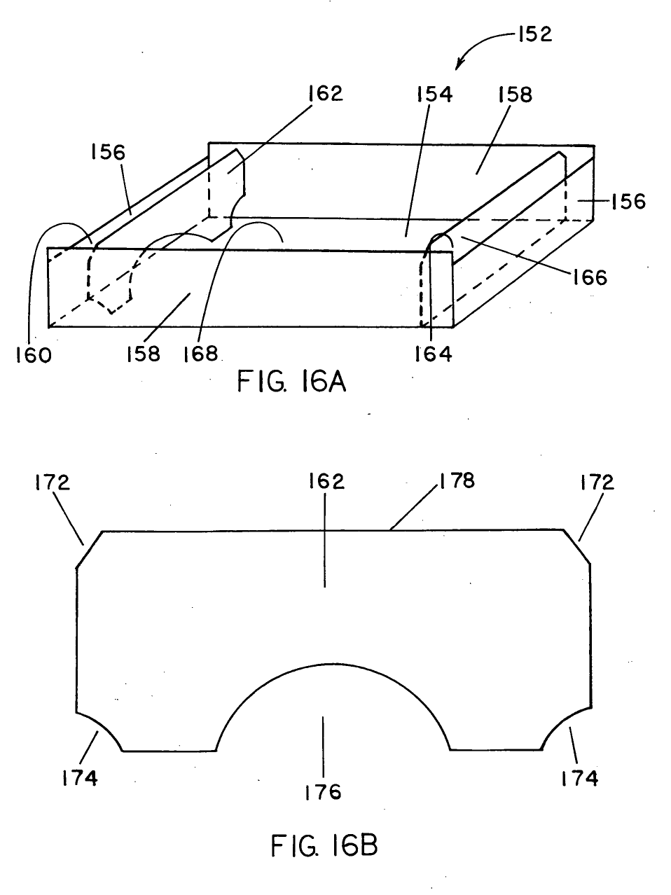

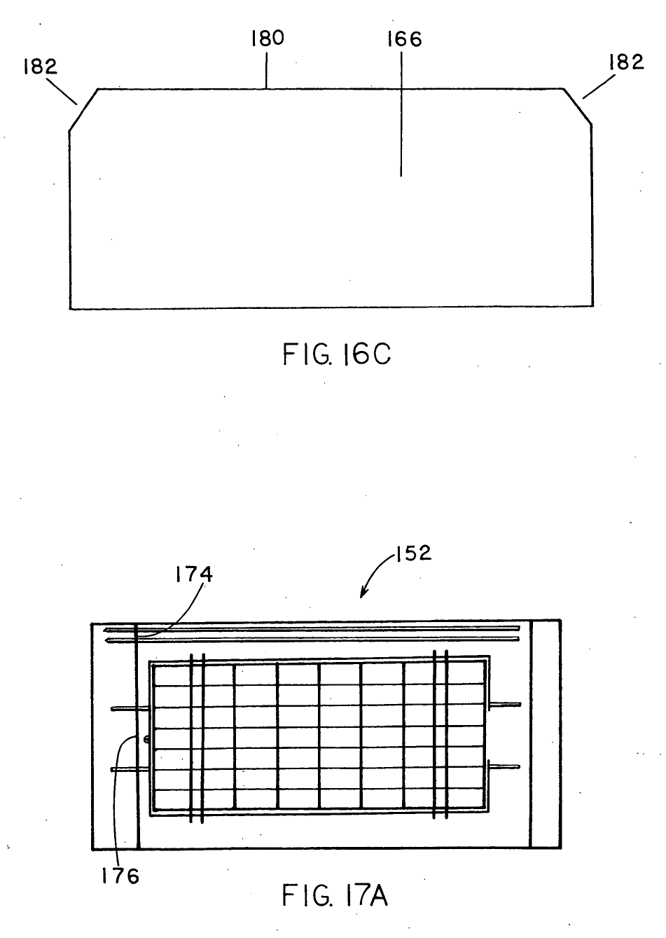

As shown in FIG. 16A, a storing case 152 has a horizontal floor 154, generally vertical two side wall 156, and two longitudinal walls 158. Height of side walls 156 is generally less than height of longitudinal walls 158. A frame chamber 160 is a space between side walls 156 and a frame chamber wall 162. An arm chamber 164 is a space between side wall 156 and arm chamber wall 166. A main storing chamber 168 is a space between frame wall 162 and arm wall 166.

FIG. 16B is an enlarged view of frame chamber wall 162. Chamber wall 162 has two corner cutouts 172 at its upper corners, two corner cutouts 174 at its lower corners, and a lower edge central cutout 176. A supporting edge 178 is the upper edge of the wall 162.

FIG. 16C is an enlarged view of arm chamber wall 166. Arm wall 166 has two upper corners cutouts 182. A supporting edge 180 is the upper edge of the wall 166.

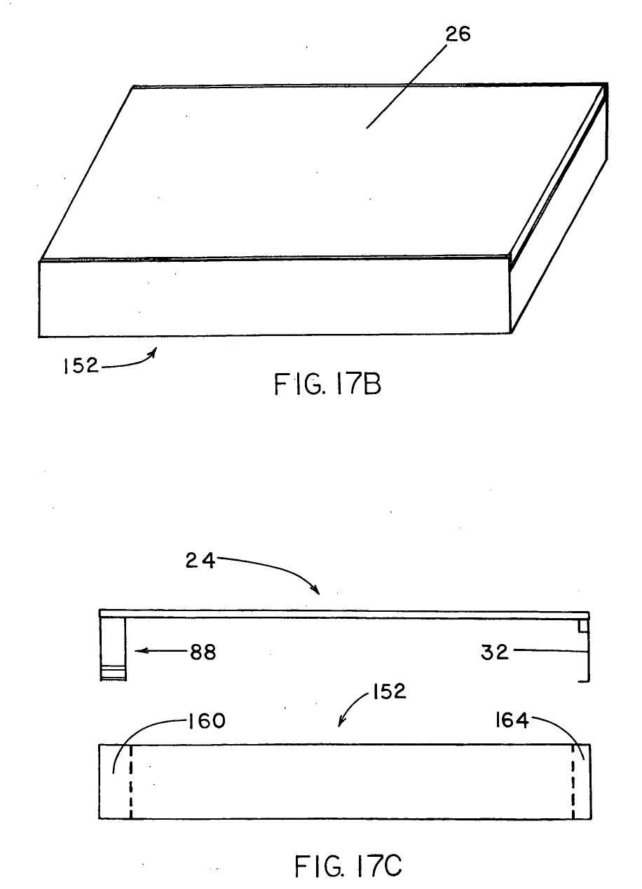

As illustrated in FIG. 17A, long gadgets inserted through lower corner cutout 174 and lower edge central cutout 176.

FIG. 17C shows rotisserie station 24 in relation to case 152. As shown in FIG. 17B, the rotisserie station inserted into case 152 and base 26 of the rotisserie station covered the case.

One of many important features of the spool rotisserie system is its storage ability. The case 152 is designed to fit any standard kitchen cabinet.

Another important feature is that the base 26 of rotisserie station 24 serving as a cover of the storing case. This facilitates assembling as well as dissembling process. During assembling the station always comes first, as it shown in FIGS. 2A and 17C. During dissembling, as shown in FIG. 17A, case 152 can accept long gadgets through its cutouts 174 and 176. All remaining parts can be put in main storing chamber 168. Walls 162 and 166 are protecting station 24 from interfering with gadgets of the main chamber. The rotisserie station is supported by edges 178 and 180, when it served as the cover.

Assembling steps of the rotisserie system are very simple. First, pull out the rotisserie station and put it on the oven. Second, insert the bearing support 40 through slot 36 into hollow member 38. Next, take the sliding spool 68 with cover 80 and spool enclosure 102. Position spool 68 on beams 100 and cover it by placing cover 80 on bars 98. Take the motor and position the spool enclosure 102 on it, by inserting shaft 112 into socket 122.

Now the rotisserie system is ready for accepting a food for cooking. Insertion of the rods in foods is the most easiest and safe technique. Each rod inserted individually and no exact positioning is required. Individual insertion is not only easiest but safe compare to those rotisseries with two fixed rods.

Once the rods were inserted in to a food, now the sharpen ends are inserted into rod receptacles 50 of the bearing assembly 46. Rods holder 60 is positioned on the opposite ends of the rods.

Holding the knob 54 of the bearing assembly by one hand and rods holder 60 by another hand carry the food to the rotisserie system. First, insert the rods into holes 58 of the sliding spool. Second place bearing 52 into ‘U’ shape head 44.

Hold arm 32 of rotisserie station by one hand and outer frame wall 92 by the other hand. Take the rotisserie system and put inside the oven cavity. As shown in FIG. 10, position the housing 76 in the gap 128 and close the oven door. Turn on the motor and start cooking.

Operational energy transmitted through the line from the motor to the rotisserie driven embodiment 70. As the motor spins motorized spool 108 winds up the line. The line passes through the housing and unwinds from sliding spool 68. As the line unwinds from the sliding spool, the spool slides over beams 100. This process of transmitting energy for spinning the food is used in the system for rotisserie cooking.

The principle of unwinding the line from one spool and winding up on another gives to the rotisserie system one more distinctive feature. During winding and unwinding circumference of the line changes, thus rotational speed changes. Generally rotisserie cooking always starts with slow speed and finishes with increased speed. Essential first step in rotisserie cooking is searing. Searing requires high heat and slow speed. In my system searing is naturally always first step.

Food lurching is resolved by invention of the conical axle construction. Food is supported by one fulcrum at the bearing assembly and by two fulcrums at sliding spool 68. Two beams of rotisserie frame 88 are the two fulcrums. As shown in FIG. 15, the size of base 208 of the conical axle is determined by the disaster between two beams. As it shown lurching is resolved by simplifying the rotisserie system. Practically was observed that even asymmetrical or unbalanced foods were not lurching.

The spool rotisserie system works in harmony with home ovens. It can be moved to different levels from the heating element. Rotisserie system can utilize all cooking techniques, such as: roasting, broiling, and convectional cooking.

It suggested to use a foil to cover the base of the rotisserie station. Melted fat will be dripping on the foil. When cooking is finished, remove the foil with the melted fat and discard it. Thus no cleaning of rotisserie station is needed.

Rewinding steps of the rotisserie system are illustrated in FIGS. 11,13,14A, and 14B. First, take the rewinding frame and insert shaft 140 in to aperture 72. Then, lose the cover and lift the cover, the spool, and the frame together. Lift these parts just enough to be able to put the frame 138 by its cheeks on the wall 90. Position the cover back on bars 98. Now spool 68 is elevated above the beams. Remove the motorized spool enclosure from the motor. Position the spool enclosure on its legs 119. Finally, hold the knob 148 and spin the spool 68 by holding the handle 150.

An alternative to the preferred embodiment is considered. It is believed that a disposable line rotisserie can coexist with preferred embodiment. Eliminating of rewinding cycle is considered as the alternative for the spool rotisserie system. In the alternative embodiment disposable line can be used. The line can be used just one time. It was learned that sliding spool has enough space to put a lot of line. For example, only ⅙ of sliding spool space is needed to have enough line for one year. This means, that you can use spool rotisserie system several days a week for a hole year without doing anything to the system. It was practically learn that slow rotisserie cooking speed gives better results than fast speed. Slow rotisserie cooking speed in home ovens cooks food faster, keeps juices better, gives exceptionally tasty food. For example: to cook two chickens rotisserie needs only about 7 spins, to cook eight salmon stakes takes approximately 4 spins or 25-30 minutes. One spin every 6 minutes is the most acceptable speed. Line made of fiberglass generally used in spool rotisserie system. Fiberglass line is harmless to human body, very strong, and heat resistant. Thin fiberglass line can be used as disposable line. After one year of work or more new fiberglass line cane be put on the sliding spool. There are many ways how new line can be obtained. Line replacement is not considered as a problem in this embodiment. Thereby, alternative spool rotisserie system with disposable line is considered.

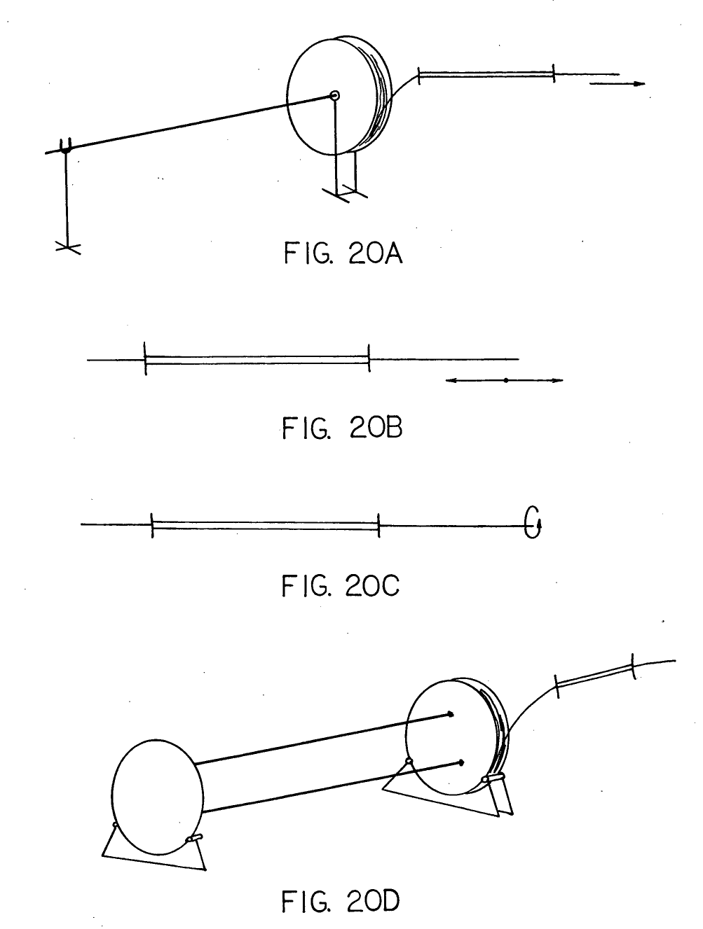

Is shown in FIG. 20A, a single axle alternative embodiment is possible. Lurching is the problem in this embodiment. More complex design is needed to overcome the problem.

An alternative way of energy transition illustrated in FIG. 20B energy can be transmitted by moving the line back and forth. In this principle special construction is needed for returning the line back. Friction in this embodiment become the major problem.

As shown in FIG. 20C, energy can be transmitted by rotating the line. In this principle friction is the major problem.

FIG. 20D show dual sliding spool constriction. Although, lurching is solved by this construction, extra friction at the second sliding spool is the problem.

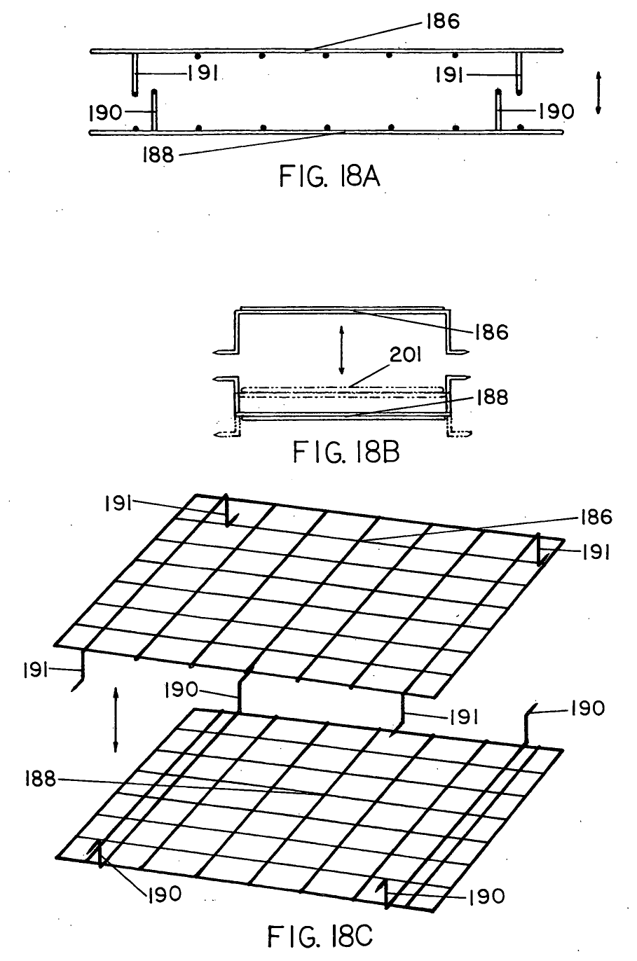

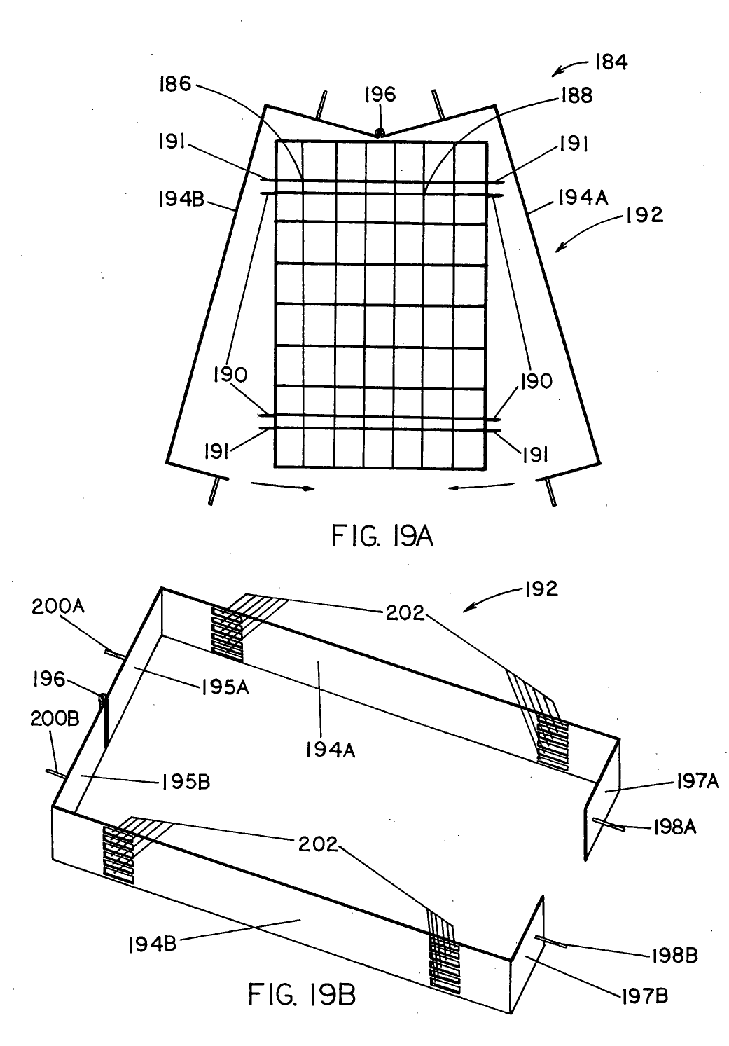

FIG. 19A show a capturing slots food basket 184. Food basket 184 comprises of a grid 186, an asymmetrical flanges grid 188, and a food basket frame 192. Grids 186 and 188 best shown in FIGS. 18A, 18B and 18C. Rectangular shape grid 186 has four “L” shape flanges 191. Flanges 191 have sharp ends and positioned in pairs on each long side of the grid. Grid 188 is generally replica of grid 186, except grid 188 has asymmetrical flanges 190. Means, that flanges 191 of the grid 186 never interfere with asymmetrical flanges 190 of the grid 188.

FIG. 19B show basket frame 192 having rectangular shape. One of frame short side has a short hinged wall 195A and a short hinged wall 195B connected together by a vertical hinge 196. The opposite short side of the frame 192 has a short not connected wall 197A and a short not connected wall 197B.

Hinged wall 195A has a spool hole corresponding finger 200A connected to the wall and hinged wall 195B has a spool hole corresponding finger 200B connected to the wall.

Not connected wall 197A has a rod receptacle corresponding finger 198A connected to the wall, and not connected wall 197B has a rod receptacle corresponding finger 198B connected to the wall.

A frame lengthwise wall 194A and a frame lengthwise wall 194B each having plurality of a horizontal capturing slots 202. Plurality of slots 202 organized in four sets and each set of slots 202 located more close to the length wise walls corners.

Phantom lines 201 in FIG. 18B show different grid 186 position.

The capturing slots food basket is easy to use and its design gives some cooking advantages. The food basket generally comprises of two grids 186, 188, and frame 192. The grids are independent constrictions and each grid having flanges. Grids have identical size but flanges of one grid positioned asymmetrically to another grid. Thereby, flanges never interfere and grids can be adjusted to different food size. That feature makes positioning of the food in the grids very easy. Just put food on one grid and cover it by the second grid.

The frame 192 has hinge 196. The hinge allows the frame to open an close in horizontal projection. Each lengthwise wall of the frame has plurality of slots 202. These slots correspond to the grids flanges.

Assembling steps of the food basket are very simple. First, position one of the grids on the countertop and place food on it. Next, take the second grid and place it over the food. Take the frame, open it up, and bring the frame around the grids. Start to close the frame and the same time capture the flanges by the slots. Capture the flanges and close the frame. Take bearing assembly 46 and insert fingers 197A and 197B into rod receptacles 50. Take the food basket and bring it to the spool rotisserie system. Insert the fingers 200A and 200B into sliding spool receiving holes 58. Position bearing assembly on bearing support 40. Now food is ready for cooking.

When the food in the basket is cooked, take the basket and place it on a plate or tray. Remove the bearing assembly. Open up the frame and remove if from the grids. Remove the top grid from the food. Serve the food piece by piece or bring the food on the bottom grid to the table.

It is advantageous that removal of the top grid is easy and helps not to brake the food. The same time the food can stay in the bottom grid and be presented to the table.

Driven by desire to have unique rotisserie system the capturing slots food basket was designed. This food basket shows its many advantageous sides. It is obvious that alternative use of the capturing slot food basket is possible. Alternatively this food basket can be successfully used for outdoors grilling.

### LIST OF REFERENCE NUMERALS

22. spool rotisserie system
24. rotisserie station
26. base
28A. side wall
28B. side wall
30. longitudinal wall
32. rainbow shape arm
34. diversion
36. slot
38. hollow upright member
40. bearing support
42. stem
44. “U” shape head
46. bearing assembly
48. bearing assembly crossbar
50. rod receptacle
52. bearing
54. bearing knob
56A. rod
56B. rod
58. rod receiving hole
60. rods holder
62. holder arm
64. holder crossbar
66. cylinder
68. sliding spool
70. rotisserie driven embodiment
72. central aperture
74. line
76. housing
78. cover holding member
80. cover
82. directional bend
84. apron
86.ogive
88. rotisserie frame
90. inner frame wall
92. outer frame wall
94A. outer wall cutout
94B. inner wall cutout
96. side cutout
98. horizontal bar
100. beam
102. motorized spool enclosure
104. cadre
106. cadre holding member
108. motorized spool
110. rotary shaft
112. driving shaft
114A. top plate
114B. bottom plate
115A. rotary shaft washer
115B. driving shaft washer
116A. driving shaft aperture
116B. rotary shaft aperture
118. bolt
119. leg
120. motor
122. rotary drive socket
124. stopper
126. oven
128. gap
130. oven body
132. oven door
134. heating element
136. countertop
138. rewinding frame
140. rewinding axle
142. frame head
144. cheek
146. frame gap
148. frame knob
150. rewinding handle
152. storing case
154. floor
156. side wall
158. lengthwise wall
160. frame chamber
162. frame chamber wall
164. arm chamber
166. arm chamber wall
168. main storing chamber
172. upper corner cutout
174. lower corner cutout
176. lower edge central cutout
178. supporting edge
180. supporting edge
182. upper corner cutout
184. capturing slots food basket
186. grid
188. asymmetrical flanges grid
190. asymmetrical flanges
191. flange
192. food basket frame
194A. frame lengthwise wall
194B. frame lengthwise wall
195A. short hinged wall
195B. short hinged wall
196. vertical hinge
197A. short not connected wall
197B. short not connected wall
198A. rod receptacle corresponding finger
198B. rod receptacle corresponding finger
200A. spool hole corresponding finger
200B. spool hole corresponding finger
201. phantom line of a different grid position
202. horizontal capturing slot
206. phantom lines of the conical axle
208. axle base
210. axle top
212. relational arrowed line

1. A spool rotisserie system comprising:
a rotisserie station having a base and a rainbow shape arm, attached to one side of said base, said arm having a bearing support; and,
a bearing assembly positioned on said bearing support, two rods for holding food inserted into rod receptacles of said bearing assembly and opposite ends of said rods inserted into rod receiving holes of a sliding spool;
said base having a rotisserie driven embodiment on the opposite side including a rotisserie frame mounted to said base and having an outer frame wall and inner frame wall connected by two beams and two horizontal bars, said sliding spool positioned on said two beams and a cover positioned on said two bars;
a housing connected to said cover by one end and to a motorized spool enclosure by the opposite end, a line winded about said sliding spool and passed through said housing and winded about a motorized spool, said motorized spool having a driving shaft engaged a rotary drive socket of a motor.

2. The rotisserie system as claimed in claim 1, further comprising the arm having a diversion at its top, said diversion having a slot which aimed downward into a hollow upright member which attached to said base.

3. The rotisserie system as claimed in claim 1, further comprising said bearing assembly having a bearing;
one side of said bearing is elongated to form a bearing knob and a bearing assembly crossbar attached to the opposite side, the crossbar having said two rod receptacles spaced apart and connected to the crossbar.

4. The rotisserie system as claimed in claim 1, further comprising said rotisserie frame having the inner wall and the outer wall wherein the both walls having identical cutouts in its mid areas of the upper edges; and the outer wall having two side cutouts of its lower corners, whereby the two side cutouts made the space for holding the wall by human arm.

5. The rotisserie system as claimed in claim 1, comprising said rotisserie station having the rainbow arm on one side and said outer frame wall on the opposite side, said outer frame wall having two lower corners side cutouts; and,
means for holding the rainbow arm by one human arm and for holding the outer wall by the other human arm, whereby holding and carrying the rotisserie system.

6. The rotisserie system as claimed in claim 1, further comprising a bearing having one side elongated to form a bearing knob and a bearing assembly crossbar attached to the opposite side, where the crossbar having said two rod receptacles spaced apart and connected to the crossbar; said one rod inserted into the food and said second rod inserted into the food and said two rods inserted into said rod receptacles of said bearing assembly, a rods holder having two cylinders spaced apart and attached to a holder crossbar where two holder arms attached to said holder crossbar, and said rods holder positioned on said two rods by inserting said rods in to said cylinders;
first means for holding said bearing knob by one the human hand and for holding said holder arm by second human hand and for carrying the food to and from said spool rotisserie system, and second means for facilitating insertion of said rods into said rod receiving holes of said sliding spool and for facilitating positioning of said bearing assembly on said bearing support.

7. The rotisserie system as claimed in claim 1, further comprising said cover having two aprons attached to inner surface and close to the ends of said cover, said cover having a directional bend and said housing attached to said directional bend.

8. The rotisserie system as claimed in claim 1, further comprising said motorizing spool enclosure having a cadre covered by a bottom plate from one side and a top plate at the opposite side and said top plate having a plurality of legs.

9. The rotisserie system as claimed in claim 1, further comprising a stopper, means for preventing from spinning of said motorized spool enclosure about said motor.

10. The rotisserie system as claimed in claim 1, comprising a process of operating rotisserie system by transmitting energy from said motor to said sliding spool through a resistant to oven operational temperature line.

11. The line as claimed in claim 10, is made of fiberglass.

12. The rotisserie system as claimed in claim 1, further comprising a method of increasing in a number of rotations per minute for the rotisserie system comprising steps:
(a) said motor having constant rotational speed is engaging said motorized spool,
(b) said line is winding about said motorized spool, wherein circumference of each following spin about said motorized spool is increased,
(c) said line is unwinding from said sliding spool, wherein circumference of each following said line spin from said sliding spool is decreasing;
whereby during rotisserie cooking number of rotations per minute of said sliding spool is increasing as cooking is progressing.

13. The rotisserie system as claimed in claim 1, further comprising a method of supporting the food by three fulcrums, wherein the food is supporting at one side by bearing support and at the opposite side is supporting by two fulcrums which are said two beams, means for eliminating food lurching.

14. The rotisserie system as claimed in claim 1, further comprising a conical axle construction.

15. The rotisserie system as claimed in claim 1, further comprising a rewinding frame, means for rewinding said line from said motorized spool to said sliding spool.

16. A spool rotisserie system comprising:
a rotisserie station having a rotisserie driven embodiment on one side and a bearing support with a bearing assembly on the opposite side, said rotisserie driven embodiment having a sliding spool positioned upon two beams of a rotisserie frame and a cover is positioned on the frame, a housing connected to said cover by one end and to a motorized spool enclosure by the other end, said motorized spool enclosure having a motorized spool engaged a motor;
food secured by two rods and support at one side by said bearing assembly and by said sliding spool at the opposite side, a line winded about said sliding spool then passed through said housing and winded about said motorized spool.

17. The rotisserie system as claimed in claim 15, further comprising a disposable line, means for spinning said sliding spool in the rotisserie system.

18. The line as claimed in claim 16, is made of fiberglass.

19. A process of operating a rotisserie system by an energy transmitting through a fiberglass line from a motor to said rotisserie system.

20. A storing case for a spool rotisserie system comprising:
(a) a floor having two side walls and two longwise walls connected to the floor;
(b) a frame chamber wall having two upper corner cutouts and two lower corner cutouts and lower edge central cutout, and the frame wall mounted inside the case parallel to the side wall;
(c) an arm chamber wall having two upper corner cutouts and mounted inside the case parallel to the side wall;
(d) thereby the arm wall and the frame wall creating a frame chamber and an arm chamber and main storing chamber, means for storing said spool rotisserie system.

21. A food basket comprising:
(a) a frame having a plurality of horizontal slots on two opposite sides and a wall without the slots having a vertical hinge, means the hinge for opening and closing said frame in horizontal projection,
(b) two grids each having a plurality of flanges on two opposite sides.

22. A capturing slots food basket for a spool rotisserie system comprising:
(a) a food basket frame having two short hinged walls connected by a vertical hinge and two short not connected walls on the opposite side, whereby said frame can be opened and closed in horizontal projection, two lengthwise frame walls having a plurality of horizontal capturing slots,
(b) a grid having two flanges on one side and two flanges on the opposite side, an asymmetrical flanges grid having two asymmetrical flanges on one side and two asymmetrical flanges on the opposite side, whereby the flanges are corresponding to the slots.

23. The food basket as claimed in claim 21 further comprising:
(a) the two hinged walls each having a spool hole corresponding finger and the two not connected walls each having a rod receptacles corresponding finger;
(b) said grid and said asymmetrical flanges grid having identical size, and said flanges and said asymmetrical flanges having “L” shape, whereby said flanges and said asymmetrical flanges never interfere.
